(19) United States
(12) Patent Application Publication
(10) Pub. No.: US 2026/0142202 A1
(43) Pub. Date: May 21, 2026

(54) ION FILTER, FUEL CELL SYSTEM COMPRISING THE SAME AND FUEL CELL VEHICLE COMPRISING THE SAME

(71) Applicants: Hyundai Motor Company, Seoul (KR); Kia Corporation, Seoul (KR)

(72) Inventors: HAELEE LEE, Hwaseong-Si (KR); DONG NYEOK PARK, Hwaseong-Si (KR)

(21) Appl. No.: 19/208,093

(22) Filed: May 14, 2025

(30) Foreign Application Priority Data
Nov. 21, 2024 (KR) 10-2024-0167378

(51) Int. Cl. H01M 8/04044; H01M 8/04029

(52) U.S. Cl. CPC H01M 8/04044; H01M 8/04029; H01M 2250/20

(57) ABSTRACT

An ion filter may comprise: a first cartridge including a first-type exchange resin; a second cartridge including a second-type exchange resin; and a third cartridge including a third exchange resin, wherein the third exchange resin is a mixture of the first-type exchange resin and the second-type exchange resin.

### CROSS-REFERENCE TO RELATED APPLICATION

This present application claims the benefit of priority to Korean Patent Application No. 10-2024-0167378, entitled “Ion filter, fuel cell system comprising the same and fuel cell vehicle comprising the same” filed on Nov. 21, 2024, in the Korean Intellectual Property Office, the entire disclosure of which is incorporated herein by reference.

### FIELD

The present disclosure relates to an ion filter, a fuel cell system comprising the same, and a fuel cell vehicle comprising the same.

### BACKGROUND

A fuel cell, which may serve as an internal combustion engine in a hydrogen electric vehicle, operates smoothly by use of a surrounding/auxiliary system. The surrounding/auxiliary system may comprise one or more of an air supply system (APS), a hydrogen supply system (FPS), or a thermal management system (TMS). The TMS serves to maintain an operating temperature of a fuel cell stack with various parts such as a pump, a coolant temperature control valve, a residual oxygen remover, a heater core, a radiator, and an ion filter.

In the case of the fuel cell, electricity is produced by a chemical reaction of hydrogen and oxygen, and the amount of heat energy generated increases accordingly, so it may be required to maintain the appropriate temperature via stack-specific coolant. Since the stack-specific coolant is injected through a flow path in a fuel cell stack separator and the operating temperature of the fuel cell is maintained via direct contact/heat exchange with the coolant. As such, an insulating property of the coolant should be secured.

An ion filter component may serve to capture residual ions in the coolant circulating through the system and maintain the electrical conductivity of the coolant. The ion filter may comprise a cartridge assembly comprising ion exchange resin and a housing assembly, and the cartridge comprising the ion exchange resin is a component that should be periodically replaced.

The stack coolant may be introduced from the bottom port of the ion filter and is discharged from the top port. Since the stack coolant goes up against the direction of gravity in the flow path, the ion exchange resin may be separated by a difference in specific gravity. In other words, a separation phenomenon occurs in which a cation exchange resin with high specific gravity is distributed at the bottom and an anion exchange resin with low specific gravity is distributed at the top. When the ion exchange resins are separated, the effect when the ion exchange resins are mixed is reduced and interaction between the ion exchange resins increases, which may prematurely reduce the durability of the ion exchange resins.

In addition, the ion exchange resin has its own moisture content (about 50%). The cation exchange resin and the anion exchange resin may experience a swelling phenomenon when they comprise moisture, so an apparent diameter of the resins increase. As the introduction and discharge of the coolant and ion exchange within the coolant take place, the ion exchange resins expand/contract repeatedly. Further, the cation exchange resin, which stagnates at the bottom of the ion filter, is subjected to physical pressure due to the swelling phenomenon of the anion exchange resin and the pressure transmitted from a wall surface. Therefore, the cation exchange resin may generate a large number of external cracks (e.g., in the cation exchange resin), and due to this effect, a functional group (sulfonic acid group, SO₃⁻) of the cation exchange resin may be adsorbed on the outside of the anion exchange resin. When the sulfonic acid functional group is adsorbed on the outside of the anion exchange resin, an ion exchangeable area is reduced, thereby reducing the exchange performance of the anion exchange resin.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for ion filter, fuel cell system comprising the same and fuel cell vehicle comprising the same. An ion filter may comprise: a first cartridge including a first-type exchange resin; a second cartridge including a second-type exchange resin; and a third cartridge including a third exchange resin, wherein the third exchange resin is a mixture of the first-type exchange resin and the second-type exchange resin.

An ion filter may also, or alternatively, comprise: a set of ion filter cartridges; a coolant inlet configured to provide coolant to at least one ion filter cartridge of the set of ion filter cartridges; a coolant outlet configured to discharge the coolant from at least one ion filter cartridge of the set of ion filter cartridges, wherein the set of ion filter cartridges comprises: a first ion filter cartridge including a first-type exchange resin; a second ion filter cartridge including a second-type exchange resin; and a third ion filter cartridge including a third exchange resin, wherein the third exchange resin is a mixture of the first-type exchange resin and the second-type exchange resin

A fuel cell system may comprise the ion filter according to the present disclosure.

A fuel cell vehicle may comprise the ion filter and/or fuel cell system according to the present disclosure.

These and other features and advantages are described in greater detail below.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a perspective view of an ion filter according to various examples of the present disclosure;

FIG. 2 is a cross-sectional view taken along line I-I′ of FIG. 1;

FIG. 3 is a cross-sectional view taken along II-II′ of FIG. 1;

FIG. 4 is a perspective view of a cartridge according to an example;

FIG. 5 is an exploded perspective view of the cartridge according to an example;

FIG. 6 is a perspective view of a cartridge according to another example;

FIG. 7 is an exploded perspective view of the cartridge according to another example;

FIG. 8 is a perspective view of a cartridge according to another example; and

FIG. 9 is an exploded perspective view of the cartridge according to another example.

### DETAILED DESCRIPTION

Hereinafter, examples disclosed in the present specification will be described in detail with reference to the accompanying drawings. In the following description, identical or similar components are given the same or similar reference numerals, and overlapping descriptions thereof may be omitted.

In this specification, terms such as “include”, “comprise” or “have” indicate the presence of features, numbers, steps, operations, components, parts, or combinations thereof described in the specification, but do not preclude any of the following: features, numbers, steps, operations, components, parts, or combinations thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The present disclosure relates to an ion filter. The present disclosure relates to an ion filter used for coolant circulation in a fuel cell system of a fuel cell vehicle.

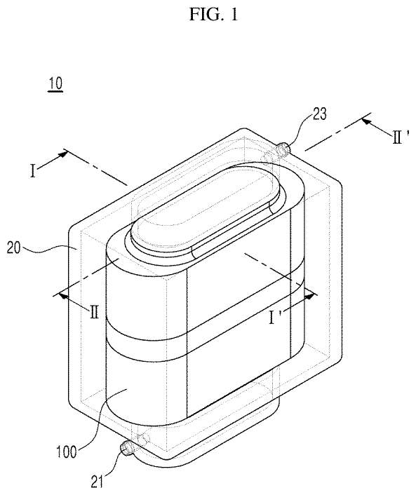

FIG. 1 is a perspective view of an ion filter according to various examples of the present disclosure.

Referring to FIG. 1, an ion filter 10 of the present disclosure may comprise a cartridge 100 and a housing 20.

The housing 20 may house the cartridge 100. The housing 20 may have a hollow cylindrical and/or prism shape.

The housing 20 may comprise a coolant inlet passage 21 and a coolant outlet passage 23. For example, the coolant inlet passage 21 may be formed at a bottom of the housing 20. The coolant outlet passage 23 may be formed at a top of the housing 20. Also, or alternatively, the coolant inlet passage 21 and the coolant outlet passage 23 may be configured such that coolant is configured to enter the housing 20 via the coolant inlet passage 21, pass upward through the cartridge 100, and exit the housing 20 via the coolant outlet passage 23.

The cartridge 100 may comprise an ion exchange resin. The ion exchange resin may be mounted inside the cartridge 100. The ion exchange resin may stagnate (e.g., remain, reside, be provided/disposed, etc.) inside the cartridge 100. An ion exchange resin having a capacity suitable for an output of the fuel cell system (e.g., suitable for filtering ions from a coolant of the fuel cell system) may stagnate in the cartridge 100.

The cartridge 100 may comprise at least any one selected from the group consisting of polypropylene (PP), polyamide (PA), and/or polyethylene (PE). However, the example is not limited thereto, and the cartridge 100 may comprise various plastic materials (e.g., with low ion elution).

The ion filter 10 of the present disclosure may remove cations and/or anions from a stack coolant and/or manage the electrical conductivity increased by cation and/or anion present in the stack coolant to a predetermined standard or lower, thereby increasing insulation stability of a vehicle.

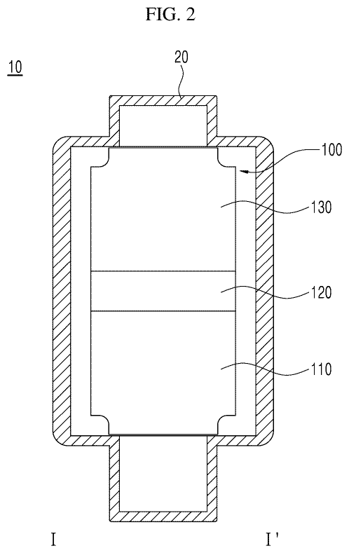

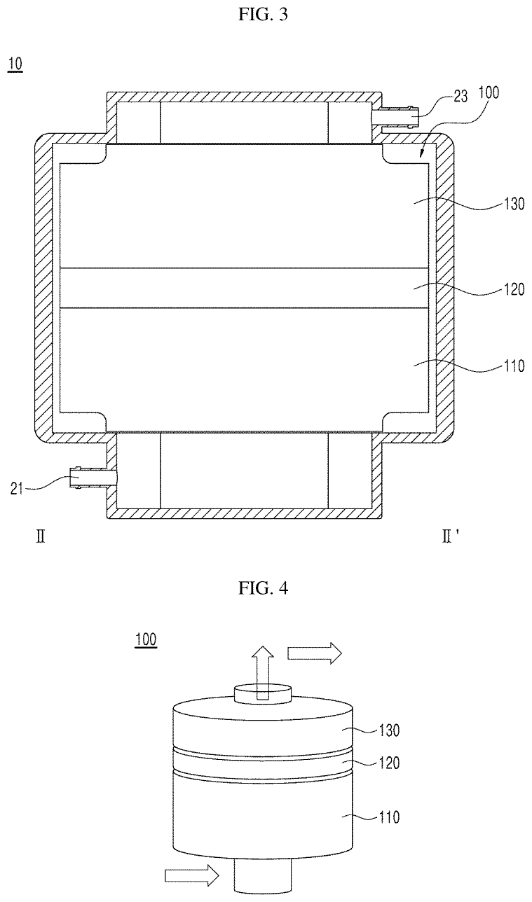

FIG. 2 is a cross-sectional view taken along line I-I′ of FIG. 1. FIG. 3 is a cross-sectional view taken along II-II′ of FIG. 1.

The cartridge 100 according to an example may comprise a plurality of cartridges. The present disclosure may avoid interaction between ion exchange resins comprised in each cartridge through use of a plurality of separated cartridges/cartridge compartments.

For example, referring to FIGS. 2 and 3, the cartridge 100 may comprise a first cartridge 110, a second cartridge 120, and a third cartridge 130. The first cartridge 110, the second cartridge 120, and the third cartridge 130 may each comprise the ion exchange resins. The types of the ion exchange resins comprised in each of the first cartridge 110, the second cartridge 120, and the third cartridge 130 may be different from each other.

The first cartridge 110 may comprise a first-type exchange resin. The first-type exchange resin may be mounted inside the first cartridge 110. The first-type exchange resin may stagnate inside the first cartridge 110. The first-type exchange resin may have a capacity suitable for the output of the fuel cell system and may stagnate in the first cartridge 110.

The first-type exchange resin may filter ions comprised in the coolant. The first-type exchange resin may be an anion exchange resin. The first-type exchange resin may exchange anions and/or preferentially exchange anions.

The anion exchange resin, which is the first-type exchange resin, may have a volume change rate of 20 to 30% (e.g., about 20 to 30%) due to a chemical reaction with ions in the coolant. The anion exchange resin may have a volume change rate of 5 to 15% (e.g., about 5 to 15%) due to swelling. Therefore, considering this volume change rate of the first-type exchange resin, a free space in the first cartridge 110 may be secured (e.g., the free space being secured before/without substantial swelling). That is, the first cartridge 110 may comprise the free space, thereby minimizing the influence due to the volume change rate of the first-type exchange resin.

The second cartridge 120 may comprise a second-type exchange resin. The second-type exchange resin may be mounted inside the second cartridge 120. The second-type exchange resin may stagnate inside the second cartridge 120. The second-type exchange resin may have a capacity suitable for the output of the fuel cell system and may stagnate in the second cartridge 120.

The second-type exchange resin may filter ions comprised in the coolant. The second-type exchange resin may be a cation exchange resin. The second-type exchange resin may exchange cation (e.g., preferentially exchange cations).

The cation exchange resin, which is the second-type exchange resin, may have a volume change rate of 5 to 15 % (e.g., about 5 to 15%) due to a chemical reaction with ions in the coolant. The cation exchange resin may have a volume change rate of 2 to 8 % (e.g., 2 to 8%) due to the swelling. Therefore, considering this volume change rate of the second-type exchange resin, a free space in the second cartridge 120 may be secured (e.g., the free space being secured before/without substantial swelling). That is, the second cartridge 120 may comprise the free space, thereby minimizing the influence due to the volume change rate of the second-type exchange resin.

The third cartridge 130 may comprise a third exchange resin. The third exchange resin may be a mixture of the first-type exchange resin and the second-type exchange resin. The third exchange resin may be mounted inside the third cartridge 130. The third exchange resin may stagnate inside the third cartridge 130. The third exchange resin may have a capacity suitable for the output of the fuel cell system may stagnate in the third cartridge 130.

The third exchange resin, the mixture of the first-type exchange resin and the second-type exchange resin may filter ions comprised in the coolant. The first-type exchange resin may be the anion exchange resin, and the second-type exchange resin may be the cation exchange resin. The ions in the coolant that have passed through the first cartridge 110 and the second cartridge 120 may be additionally removed via the third cartridge 130. Therefore, the coolant quality may be improved.

The third exchange resin may have a volume change rate of 2 to 8% (e.g., about 2 to 8%) due to the swelling. Therefore, considering this volume change rate, a free space in the third cartridge 130 may be secured (e.g., the free space being secured before/without substantial swelling). By comprising the free space, the third cartridge 130 may minimize the influence due to the volume change rate of the mixed resin.

A mixing ratio of the first-type exchange resin and the second-type exchange resin comprised in the third cartridge 130 may be the same as a ratio of the first-type exchange resin comprised in the first cartridge 110 and the second-type exchange resin comprised in the second cartridge 120.

A total ratio of the anion exchange resin and cation exchange resin that stagnate in the first cartridge 110, the second cartridge 120, and the third cartridge 130 may be the same as the mixing ratio of the anion exchange resin and the cation exchange resin comprised in the third cartridge 130. Here, the ratio may be a weight ratio.

For example, the mixing ratio of the first-type exchange resin:second-type exchange resin comprised in the third cartridge 130 may be 3:1 to 5:1 (e.g., about 3:1 to about 5:1). For example, the total ratio of the anion exchange resin and cation exchange resin stagnates in the first cartridge 110, the second cartridge 120, and the third cartridge 130 may be 3:1 to 5:1 (e.g., about 3:1 to about 5:1).

Preferably, the mixing ratio of the first-type exchange resin: second-type exchange resin comprised in the third cartridge 130 may be 4:1 (about 4:1). That is, the total ratio of the anion exchange resin and cation exchange resin that stagnate in the first cartridge 110, the second cartridge 120, and the third cartridge 130 may be 4:1 (about 4:1).

The first cartridge 110, the second cartridge 120, and the third cartridge 130 may be sequentially stacked in one direction. The first cartridge 110, the second cartridge 120, and the third cartridge 130 may be sequentially disposed according to a direction in which the coolant flows. The first cartridge 110, the second cartridge 120, and the third cartridge 130 may be disposed according to the direction in which the coolant flows. The coolant in the cartridge 100 may sequentially flow through the first cartridge 110, the second cartridge 120, and the third cartridge 130.

Therefore, the coolant may sequentially flow through the anion exchange resin, the cation exchange resin, and the mixed resin. As a result, it is possible to improve the quality of the coolant and improve the durability of the ion exchange resin.

The first cartridge 110, the second cartridge 120, and the third cartridge 130 may be joined by at least any one method selected from the group consisting of vibration fusion, heat fusion, and/or insert injection. The first cartridge 110, the second cartridge 120, and the third cartridge 130 may be joined to form one cartridge 100 assembly. Therefore, if the cartridge should be replaced, the cartridge may be easily replaced by replacing the one cartridge 100 assembly.

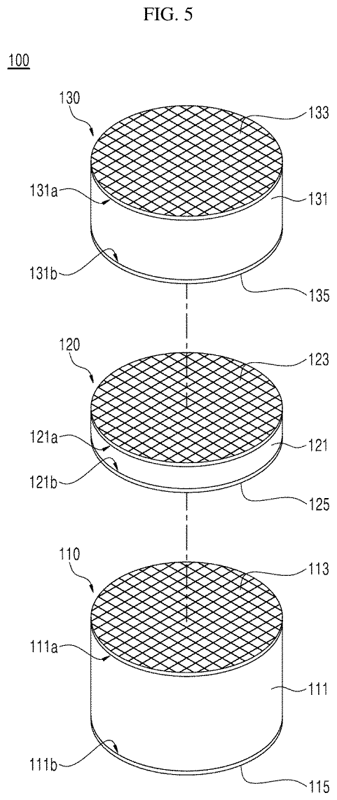

FIG. 4 is a perspective view of the cartridge according to an example. FIG. 5 is an exploded perspective view of the cartridge according to an example.

Referring to FIGS. 4 and 5, the cartridge 100 may comprise the first cartridge 110, the second cartridge 120, and the third cartridge 130. The coolant may flow along the direction of the arrows in FIG. 4. The first cartridge 110, the second cartridge 120, and the third cartridge 130 may be vertically stacked. The first cartridge 110, the second cartridge 120, and the third cartridge 130 may be sequentially stacked in a vertical direction. For example, the first cartridge 110 may be disposed at the bottom of the cartridge 100 so as to come into first contact with the coolant. The second cartridge 120 and the third cartridge 130 may be stacked on the first cartridge 110.

Since the first cartridge 110, the second cartridge 120, and the third cartridge 130 are vertically stacked, the ion exchange resin stagnant in each cartridge may be evenly used. Therefore, the life of the ion filter may be extended.

At least one surface of the first cartridge 110, the second cartridge 120, and the third cartridge 130 (e.g., at least one surface of all three and/or of each cartridge) may comprise a mesh layer.

For example, referring to FIG. 5, the first cartridge 110 may comprise a cartridge body 111 and mesh layers 113 and 115 (opposite to mesh layer 113). The first-type exchange resin may stagnate within the cartridge body 111.

The cartridge body 111 may comprise a first surface 111a and a second surface 111b. The cartridge body 111 comprises the first surface 111a corresponding to an upper surface and the second surface 111b corresponding to a lower surface. The mesh layers 113 and 115 may be disposed on the first surface 111a and the second surface 111b, respectively. That is, the mesh layer 115 may be disposed on the second surface 111b into which the coolant is introduced. In addition, the mesh layer 113 may be disposed on the first surface 111a facing the second cartridge 120.

The mesh layers 113 and 115 may guide the flow of the coolant. The mesh layers 113 and 115 may have openings of a size that prevents the first-type exchange resin comprised in the first cartridge 110 from being eluted. The diameter of the openings of the mesh layers 113 and 115 may be smaller than the diameter of the first-type exchange resin. For example, the diameter of the first-type exchange resin may be 0.3 to 0.6 mm (e.g., about 0.3 to 0.6 mm), and the diameter of the openings of the mesh layers 113 and 115 may be less than 0.2 mm (e.g., less than about 0.2 mm).

The mesh layers 113 and 115 may comprise a material with low ion elution properties. For example, the mesh layers 113 and 115 may comprise stainless steel (SUS).

The second cartridge 120 may comprise a cartridge body 121 and mesh layers 123 and 125. The second-type exchange resin may stagnate within the cartridge body 121.

The cartridge body 121 may comprise a first surface 121a and a second surface 121b. The cartridge body 121 may comprise the first surface 121a corresponding to an upper surface and the second surface 121b corresponding to a lower surface. The mesh layers 123 and 125 may be disposed on the first surface 121a and the second surface 121b, respectively. For example, the mesh layer 125 may be disposed on the second surface 121b into which the coolant is introduced from the first cartridge 110. For example, the mesh layer 123 may be disposed on the first surface 121a facing the third cartridge 130.

The mesh layers 123 and 125 may guide the flow of the coolant. The mesh layers 123 and 125 may have openings of a size that prevents the second-type exchange resin comprised in the second cartridge 120 from being eluted. The diameter of the openings of the mesh layers 123 and 125 may be smaller than the diameter of the second-type exchange resin. For example, the diameter of the second-type exchange resin may be 0.3 to 0.6 mm (about 0.3 to 0.6 mm), and the diameter of the openings of the mesh layers 123 and 125 may be less than 0.2 mm (e.g., less than about 0.2 mm).

The mesh layers 123 and 125 may comprise a material with low ion elution properties. For example, the mesh layers 123 and 125 may comprise stainless steel (SUS).

The third cartridge 130 may comprise a cartridge body 131 and mesh layers 133 and 135. The mixed resin of the first-type exchange resin and the second-type exchange resin may stagnate inside the cartridge body 131.

The cartridge body 131 may comprise a first surface 131a and a second surface 131b. The cartridge body 131 may comprise the first surface 131a corresponding to an upper surface and the second surface 131b corresponding to a lower surface. The mesh layers 133 and 135 may be disposed on the first surface 131a and the second surface 131b, respectively. For example, the mesh layer 135 may be disposed on the second surface 131b into which the coolant is introduced from the second cartridge 120. For example, the mesh layer 133 may be disposed on the first surface 131a through which coolant may be discharged.

The mesh layers 133 and 135 may guide the flow of the coolant. The mesh layers 133 and 135 may have openings of a size that prevents the mixed resin of the first-type exchange resin and the second-type exchange resin comprised in the third cartridge 130 from being eluted. The diameter of the openings of the mesh layers 133 and 135 may be smaller than the diameter of the mixed resin. For example, the diameter of the mixed resin may be 0.3 to 0.6 mm (e.g., about 0.3 to 0.6 mm), and the diameter of the openings of the mesh layers 133 and 135 may be less than 0.2 mm (e.g., less than about 0.2 mm).

The mesh layers 133 and 135 may comprise a material with low ion elution properties. For example, the mesh layers 133 and 135 may comprise stainless steel (SUS).

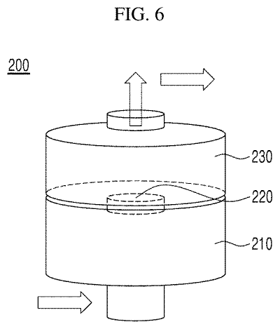

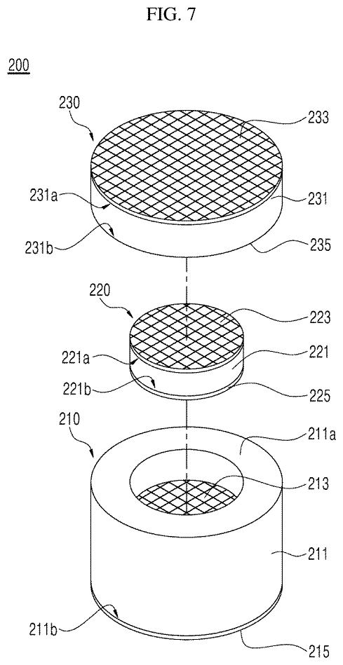

FIG. 6 is a perspective view of a cartridge according to another example. FIG. 7 is an exploded perspective view of the cartridge according to another example.

Referring to FIGS. 6 and 7, a cartridge according to another example will be described. Detailed descriptions of the same or similar contents as described elsewhere herein will be omitted.

Referring to FIGS. 6 and 7, the cartridge 200 may comprise a first cartridge 210, a second cartridge 220, and a third cartridge 230. The coolant may flow along the direction of the arrow(s) in FIG. 6. The first cartridge 210, the second cartridge 220, and the third cartridge 230 may be vertically stacked. The first cartridge 210, the second cartridge 220, and the third cartridge 230 may be sequentially stacked in the vertical direction. For example, the first cartridge 210 may be disposed at the bottom of the cartridge 200 so as to come into first contact with the coolant. The second cartridge 220 and the third cartridge 230 may be stacked on the first cartridge 210. The second cartridge 220 may be built into the first cartridge 210.

FIGS. 6-7 illustrate that the second cartridge 220 is built into the first cartridge 210, but the example is not limited thereto. For example, the second cartridge 220 may also, or alternatively, be built into the third cartridge 230.

As a result, it may be possible to reduce the volume of the entire cartridge. In the fuel cell vehicle, the ion filter may be a component that is located at the top of an engine room for the cartridge replacement and may be connected to a vehicle body frame. Therefore, if the size of the housing in which the cartridge is mounted becomes/is large, the rigidity of the bracket connected to the frame may be a concern, so it may be beneficial to keep the volume of the cartridge small.

At least any one surface of the first cartridge 210, the second cartridge 220, and the third cartridge 230 may comprise a mesh layer.

For example, referring to FIG. 7, the first cartridge 210 may comprise a cartridge body 211 and mesh layers 213 and 215. The first-type exchange resin may stagnate within the cartridge body 211.

The cartridge body 211 may comprise a space in which the second cartridge 220 may be built and/or placed. The mesh layer 215 may be disposed on a second surface 211b into which the coolant is introduced in the cartridge body 211. In addition, the mesh layer 213 may be disposed on a surface of the cartridge body 211 corresponding to the second cartridge 220. The mesh layer 213 may have a size corresponding to a surface area of a surface (e.g., second surface 221b) of the second cartridge 220.

The second cartridge 220 may have a size and/or volume smaller than the first cartridge 210. The second cartridge 220 may have a size and/or shape so that the second cartridge 220 may be built/placed into the first cartridge 210.

The second cartridge 220 may comprise a cartridge body 221 and mesh layers 223 and 225. The second-type exchange resin may stagnate within the cartridge body 221.

The cartridge body 221 comprises a first surface 221a and a second surface 221b. The cartridge body 221 comprises the first surface 221a corresponding to an upper surface and the second surface 221b corresponding to a lower surface. The mesh layers 223 and 225 may be disposed on the first surface 221a and the second surface 221b, respectively. That is, the mesh layer 225 may be disposed on the second surface 221b into which the coolant is introduced from the first cartridge 210. In addition, the mesh layer 223 may be disposed on the first surface 221a facing the third cartridge 230.

The third cartridge 230 may comprise a cartridge body 231 and mesh layers 233 and 235. The mixed resin of the first-type exchange resin and the second-type exchange resin may stagnate inside the third cartridge 231.

The cartridge body 231 may comprise a first surface 231a and a second surface 231b. The cartridge body 231 may comprise the first surface 231a corresponding to an upper surface and the second surface 231b corresponding to a lower surface. The mesh layers 233 and 235 may be disposed on the first surface 231a and the second surface 231b, respectively. For example, the mesh layer 235 may be disposed on the second surface 231b into which the coolant is introduced from the second cartridge 220. For example, the mesh layer 233 may be disposed on the first surface 231a through which coolant is discharged.

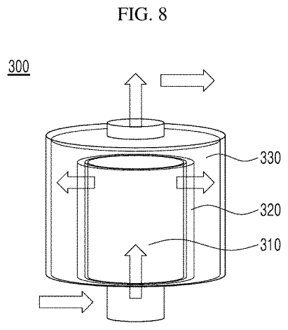

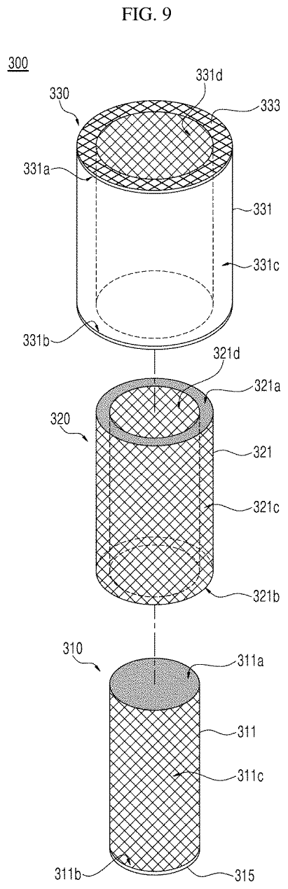

FIG. 8 is a perspective view of a cartridge according to another example. FIG. 9 is an exploded perspective view of the cartridge according to the other example.

A cartridge according to another example will be described with reference to FIGS. 8 and 9. Detailed descriptions of the same or similar contents as described above will be omitted.

Referring to FIGS. 8 and 9, the cartridge 300 may comprise the first cartridge 310, the second cartridge 320, and the third cartridge 330. The coolant may flow along the arrow direction of FIG. 8. That is, the coolant may flow vertically and/or horizontally within the cartridge 300.

At least any one surface of the first cartridge 310, the second cartridge 320, and the third cartridge 330 may comprise a mesh layer.

For example, referring to FIG. 9, the first cartridge 310 may have a cylindrical shape (e.g., extending in the longitudinal direction of the housing 20). The second surface 311b, into which the coolant is introduced from the first cartridge 310, may comprise a mesh layer 315.

The first cartridge 310 may comprise a circumferential surface 311c, which is a side surface of a cylinder, and the circumferential surface 311c may be formed as and/or to include the mesh layer. The first surface 311a, which is an upper surface of the first cartridge 310, may have a structure that is blocked so that the coolant cannot flow through the first surface 311a. Accordingly, the coolant introduced from the lower portion of the first cartridge 310 may flow in the horizontal direction of the first cartridge 310. That is, the coolant may flow not only in a longitudinal direction of the first cartridge 310 (e.g., up in FIG. 9) but also in a direction intersecting the longitudinal direction (e.g., outward).

The second cartridge 320 may be disposed to surround the first cartridge 310 (e.g., to surround a side surface 311 of the first cartridge 311. That is, the first cartridge 310 may be built into the second cartridge 320.

The second cartridge 320 may have a cylindrical shape comprising an internal space. The second cartridge 320 may comprise an outer circumferential surface 312c and an inner circumferential surface 321d. The mesh layer may be disposed on the outer circumferential surface 312c and/or the inner circumferential surface 321d, respectively. For example, the mesh layer may be disposed on a surface of the second cartridge 320 facing the first cartridge 310 and a surface of the second cartridge 320 facing the third cartridge 330.

The second cartridge 320 may comprise a first surface 321a, which may be an upper surface, and a second surface 321b, which may be a lower surface. the first surface 321a and the second surface 321b may have a structure that is blocked so that the flow of coolant is not possible through those surfaces. The coolant introduced from the first cartridge 310 may flow in the horizontal direction through the second cartridge 320. For example, the coolant may flow not only in a longitudinal direction (e.g., vertical direction) of the second cartridge 320, but also in a direction intersecting the longitudinal direction (e.g., an outward direction).

The third cartridge 330 may be disposed to surround the second cartridge 320. For example, the first cartridge 310 and the second cartridge 320 may be built into the third cartridge 330.

The third cartridge 330 may have a cylindrical shape comprising an internal space. The third cartridge 330 may comprise an inner circumferential surface 331d, and the mesh layer may be disposed on an inner circumferential surface 331d. For example, the mesh layer may be disposed on the surface of the third cartridge 330 facing the second cartridge 320.

The third cartridge 330 may comprise an outer circumferential surface 331c, and the outer circumferential surface 331c may have a structure that is blocked so that the coolant flow is not possible through the outer circumferential surface 331c. The third cartridge 330 may comprise a first surface 331a, which is an upper surface, and the mesh layer may be disposed on the first surface 331a. The coolant introduced from the second cartridge 320 may be discharged via the upper surface of the third cartridge 330.

In FIG. 9, the first surface 331a of the third cartridge 330 is illustrated as having a structure that is perforated to correspond to the size of the second cartridge 320, but the example is not limited thereto. That is, the entire first surface 331a of the third cartridge 330 may be formed as the mesh layer without the perforated structure, and the second cartridge 320 may be built into the third cartridge 330.

In the ion filter, a section where the ion exchange resin is charged may become a section that generates a coolant pressure difference (differential pressure) between an inlet side and an outlet side. In the present example, the flow of the coolant in the cartridge 300 may occur not only in the longitudinal direction (e.g., vertical direction) of the cartridge 300 but also in a direction (e.g., horizontal direction) intersecting the longitudinal direction, so that the effect of the differential pressure may be minimized. Therefore, the differential pressure caused by the ion exchange resin may be reduced, so that the coolant may pass smoothly, and the contact time between the ion exchange resin and the coolant may increase, thereby maximizing the ion filtering effect. For example, even if the operating state of the ion filter is maintained for a short period of time, the ion conductivity of the coolant may be recovered.

The present disclosure provides an ion filter with increased durability, a fuel cell system comprising the same, and a fuel cell vehicle comprising the same.

According to an example of the present disclosure, an ion filter may comprise: a first cartridge comprising a first-type exchange resin; a second cartridge comprising a second-type exchange resin; and a third cartridge comprising a third exchange resin, wherein the third exchange resin is a mixture of the first-type exchange resin and the second-type exchange resin.

In an ion filter according to an example of the present disclosure, at least one surface of the first cartridge, the second cartridge, and the third cartridge may comprise a mesh layer.

In an ion filter according to an example of the present disclosure, the first cartridge may comprise a mesh layer disposed on a surface facing the second cartridge.

In an ion filter according to an example of the present disclosure, the second cartridge may comprise mesh layers disposed on a surface facing the first cartridge and a surface facing the third cartridge, respectively.

In an ion filter according to an example of the present disclosure, the third cartridge may comprise a mesh layer disposed on a surface facing the second cartridge.

In an ion filter according to an example of the present disclosure, the first cartridge, the second cartridge, and the third cartridge may be sequentially stacked in one direction.

In an ion filter according to an example of the present disclosure, the second cartridge may be disposed to surround the first cartridge, and the third cartridge may be disposed to surround the second cartridge.

In an ion filter according to an example of the present disclosure, a flow of coolant within the ion filter may be formed in an order of the first cartridge, the second cartridge, and the third cartridge.

In an ion filter according to an example of the present disclosure, the first-type exchange resin may be an anion exchange resin.

In an ion filter according to an example of the present disclosure, the second-type exchange resin may be a cation exchange resin.

In an ion filter according to an example of the present disclosure, a mixing ratio of the first-type exchange resin and the second-type exchange resin comprised in the third cartridge may be the same as a ratio of the first-type exchange resin comprised in the first cartridge and the second-type exchange resin comprised in the second cartridge.

According to another example of the present disclosure, a fuel cell system may comprise the ion filter described above.

According to still another example of the present disclosure, a fuel cell vehicle may comprise the ion filter and the fuel cell system described above.

The ion filter according to various examples of the present disclosure can avoid the interaction between the ion exchange resins comprised in each cartridge through the plurality of cartridges. Therefore, it is possible to improve the chemical and mechanical deterioration phenomenon of the ion exchange resin, and increase the life and durability of the ion exchange resin. In other words, it is possible to improve the quality of the ion filter and increase the replacement cycle of the ion filter to reduce costs.

In addition, by improving the quality of the coolant, it is possible to resolve the problem of occurrence of the electrical conductivity, the problem of the stack current leakage, and the problem of the electrical safety of the fuel cell system and the fuel cell vehicle.

The effects of the present disclosure are not limited to those mentioned above, and other effects not mentioned can be clearly understood by those skilled in the art from the following description.

A fuel cell system of the present disclosure may comprise the ion filter described above. The fuel cell system of the present disclosure may comprise the ion filter described above, thereby solving the problem of occurrence of the electrical conductivity, the problem of the stack current leakage, and the problem of the electrical safety.

A fuel cell vehicle of the present disclosure may comprise the ion filter and the fuel cell system described above. The fuel cell vehicle of the present disclosure may comprise the ion filter described above, thereby improving the reliability of the fuel cell vehicle.

Hereinabove, examples of the present disclosure have been described with drawings. This is illustrative, and the present disclosure is not limited to the contents of the above-described examples and drawings.

It is obvious to those skilled in the art that the present disclosure can be modified within the scope of the disclosed technical idea. The described examples should be viewed as part of the present disclosure, and the scope of the present disclosure should not be limited only to the described examples.

The scope of the present disclosure should be judged by the technical idea described in the claims. In addition, even if the actions or effects according to the configuration are not explicitly described while describing the examples of the present disclosure, it is obvious that the actions or effects that are predictable by the configuration should be recognized as the present disclosure.

1. An ion filter, comprising:
a first cartridge including a first-type exchange resin;
a second cartridge including a second-type exchange resin; and
a third cartridge including a third exchange resin, wherein the third exchange resin is a mixture of the first-type exchange resin and the second-type exchange resin.

2. The ion filter of claim 1, wherein a mesh layer is disposed on at least one of: a surface of the first cartridge, a surface of the second cartridge, or a surface of the third cartridge.

3. The ion filter of claim 1, wherein the first cartridge comprises a mesh layer disposed on a surface facing the second cartridge.

4. The ion filter of claim 1, wherein the second cartridge comprises:
a first mesh layer disposed on a surface facing the first cartridge; and
a second mesh layer disposed on a surface facing the third cartridge.

5. The ion filter of claim 1, wherein the third cartridge comprises a mesh layer disposed on a surface facing the second cartridge.

6. The ion filter of claim 1, wherein the first cartridge, the second cartridge, and the third cartridge are sequentially stacked in a direction.

7. The ion filter of claim 1, wherein:
the second cartridge is disposed to surround the first cartridge, and
the third cartridge is disposed to surround the second cartridge.

8. The ion filter of claim 1, wherein the ion filter is configured to allow a flow of coolant from the first cartridge to the second cartridge and from the second cartridge to the third cartridge.

9. The ion filter of claim 1, wherein the first-type exchange resin is an anion exchange resin.

10. The ion filter of claim 1, wherein the second-type exchange resin is a cation exchange resin.

11. The ion filter of claim 1, wherein a mixing ratio of the first-type exchange resin in the third cartridge to the second-type exchange resin in the third cartridge is equal to a ratio of the first-type exchange resin in the first cartridge to the second-type exchange resin in the second cartridge.

12. The ion filter of claim 1, wherein a mixing ratio of the first-type exchange resin in the mixture and the second-type exchange resin in the mixture is in a range of 3:1 to 5:1,
wherein the first-type exchange resin is an anion exchange resin, and
wherein the second-type exchange resin is a cation exchange resin.

13. The ion filter of claim 1, further comprising:
a coolant inlet at a lower end of the ion filter; and
a coolant outlet at an upper end of the ion filter.

14. The ion filter of claim 1, further comprising:
a coolant inlet configured to provide coolant into the first cartridge; and
a coolant outlet configured to discharge the coolant from the third cartridge.

15. The ion filter of claim 1, wherein the second cartridge has a smaller volume than the first cartridge.

16. The ion filter of claim 1, further comprising:
a first mesh layer, between the first cartridge and the second cartridge, configured to allow flow of coolant between the first cartridge and the second cartridge without allowing transfer of the first-type exchange resin or the second-type exchange resin; and
a second mesh layer, between the second cartridge and the third cartridge, configured to allow flow of coolant between the second cartridge and the third cartridge without allowing transfer of the second-type exchange resin or the third exchange resin.

17. The ion filter of claim 1, wherein the first cartridge is attached to the second cartridge and the second cartridge is attached to the third cartridge.

18. A fuel cell system comprising the ion filter according to claim 1.

19. A fuel cell vehicle comprising the ion filter according to claim 1.

20. An ion filter, comprising:
a set of ion filter cartridges;
a coolant inlet configured to provide coolant to at least one ion filter cartridge of the set of ion filter cartridges;
a coolant outlet configured to discharge the coolant from at least one ion filter cartridge of the set of ion filter cartridges, wherein the set of ion filter cartridges comprises:
a first ion filter cartridge including a first-type exchange resin;
a second ion filter cartridge including a second-type exchange resin; and
a third ion filter cartridge including a third exchange resin, wherein the third exchange resin is a mixture of the first-type exchange resin and the second-type exchange resin.
